(19) United States
(12) Patent Application Publication
(10) Pub. No.: US 2024/0346837 A1
(43) Pub. Date: Oct. 17, 2024

(54) OBJECT IDENTIFICATION BASED ON MACHINE VISION AND 3D MODELS

(71) Applicant: Materialise N.V., Leuven (BE)

(72) Inventor: Bram ACKE, Leuven (BE)

(21) Appl. No.: 18/757,104

(22) Filed: Jun. 27, 2024

Related U.S. Application Data
(63) Continuation of application No. PCT/US2023/010030, filed on Jan. 3, 2023.
(60) Provisional application No. 63/266,811, filed on Jan. 14, 2022.

(51) Int. Cl. G06V 20/64; G06V 10/77; G06V 10/774; G06V 10/82; G06V 20/40

(52) U.S. Cl. CPC G06V 20/64; G06V 10/7715; G06V 10/774; G06V 10/82; G06V 20/40

(57) ABSTRACT

Certain aspects of the present disclosure generally relate to identifying one or more objects, such as by a computer vision system. In an example, parameters of images of the objects that are produced (e.g., by addictive manufacturing or traditional machining methods) are provided to a trained neural network. The neural network may have been trained to identify the objects based on parameters of 2D images of renders of 3D digital representations of the objects. In some cases, the neural network may also report any missing or different objects among the physical objects.

### CROSS REFERENCE TO RELATED APPLICATIONS

This application is a continuation of International Application No. PCT/US2023/010030, filed on Jan. 3, 2023, which claims the benefit of and priority to U.S. Provisional Patent Application No. 63/266,811, filed Jan. 14, 2022, both of which are herein incorporated by reference in their entirety as if fully set forth below and for all applicable purposes.

### FIELD OF THE INVENTION

This application relates to machine vision.

### BACKGROUND

Additive manufacturing, also referred to as 3D printing, enables layer-by-layer formation of objects. Within a build volume of an additive manufacturing device, multiple disconnected objects (e.g., parts) may be formed during a single additive manufacturing cycle within the build volume, meaning at the same time. Furthermore, because objects are created on demand, different sets of objects may be manufactured within the same build volume as needed. Printing multiple objects (also referred to as nesting) optimizes the use of the build volume as multiple objects can be manufactured at the same time during an additive manufacturing cycle.

When nesting is used, however, the chances may increase for one or more objects being manufactured incorrectly. A failure may occur for any number of reasons, such as due to random errors in adhesion of the object to the build plate, warpage of the object, deformation of the object, etc. Further, due to similarity of certain objects, it may be difficult to quickly distinguish one object from another. Accordingly, conventionally, the printed objects may be visually inspected by a user to identify each object, such as to determine any missing or incorrectly manufactured object. This can be tedious and inaccurate, especially when a large number of objects are nested in a single cycle.

Accordingly, techniques for automatically and accurately identifying objects are desired.

It should be noted that the information included in the Background section herein is simply meant to provide a reference for the discussion of certain embodiments in the Detailed Description. None of the information included in this Background should be considered as an admission of prior art.

### SUMMARY

Certain embodiments provide a method for identifying one or more objects by a computer vision system, comprising: obtaining, for each of the one or more objects, a plurality of 2D representations of the object; generating, for each of the one or more objects, a plurality of image codes, the generating comprising inputting, for each of the plurality of 2D representations of the object, the 2D representation into a first machine-leaning model and receiving as output a corresponding image code; using supervised learning to train a second machine-learning model on a dataset comprising, for each of the plurality of image codes of each of the one or more objects, the image code labelled with an identifier of a corresponding object; inputting one or more captured images of a physical representation of a first object of the one or more objects into the first machine-learning model; receiving a first image code in response to the inputting the one or more captured images; inputting the first image code into the second machine-learning model; and determining a first identifier corresponding to the first object in response to the inputting the first image code.

Further embodiments include a non-transitory computer-readable storage medium storing instructions that, when executed by a computer system, cause the computer system to perform the method set forth above, a computer system including at least one processor and memory configured to cause a computer system carry out the method set forth above, and/or a computer system including various means for carrying out the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computer vision system for identifying objects, according to aspects of the present disclosure.

FIG. 2 depicts an example block diagram of object identification, according to aspects of the present disclosure.

FIG. 3 depicts an example machine learning model, according to aspects of the present disclosure.

FIG. 4 depicts an example object identification process and output, according to aspects of the present disclosure.

FIG. 5 depicts an example method for identifying one or more objects, according to some embodiments.

FIG. 6 depicts a functional block diagram of a computer, according to some embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In the following description, details are set forth by way of example to facilitate an understanding of the disclosed subject matter. It should be apparent to a person of ordinary skill in the field, however, that the disclosed implementations are exemplary and not exhaustive of all possible implementations. Thus, it should be understood that reference to the described examples is not intended to limit the scope of the disclosure. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Embodiments of the present disclosure provide systems and methods for identifying one or more objects, such as by a computer vision system. Certain aspects are discussed herein with respect to identifying objects based on a finite dataset, such as a set of objects being manufactured within a build volume of an additive manufacturing device during a single manufacturing cycle. However, it should be noted that the techniques discussed herein may also be applicable to other types of computer vision systems. For example, other 3D object recognition scenarios based on a known set of 3D shapes may be implemented outside of the field of addictive manufacturing, such as other manufacturing fields (e.g., CNC) or other non-manufacturing fields.

In one example, a number of physical objects may be provided for recognition or identification using computer vision. A virtual counterpart, such as a 3D digital representation (e.g., CAD file, digital file, STL file, etc.), of each of the number of the objects is also provided, each 3D digital representation having a corresponding identifier (e.g., label) for the object. For example, the 3D digital representation may also be a representation used to actually manufacture the physical object, such as using additive manufacturing. Aspects of the present disclosure provide techniques for identifying each of the number of physical objects.

In an example use case, images of the actual physical objects (e.g., images captured using one or more image capturing devices, such as a camera, after manufacture of the objects) are input into a machine learning system. In certain aspects, multiple images of each physical object may be input, such as corresponding to different orientations/viewpoints of the physical object. The machine learning system may output, for each image, an identifier(s) of the object(s) in the image.

In certain aspects, the machine learning system has previously been specifically trained, at least in part, using the 3D digital representations of the physical objects, in order to better identify the physical objects in the images. In certain aspects, the machine learning system is trained using 2D rendered images that are rendered using the 3D digital representations of the objects. For example, 3D digital representations may be used to virtually generate 2D virtual depictions of the objects referred to as 2D rendered images. In certain aspects, multiple 2D rendered images of each object may be generated, such as corresponding to different orientations/viewpoints of the object. Identifiers of the object depicted in each of the 2D rendered images may be provided as part of a learning process, such as a supervised learning process, such that the machine learning system learns to associate the depiction of the object with the identifier of the object.

Details of the training of the machine learning system and identification techniques are described below. In particular, certain aspects herein leverage the use of two different machine learning algorithms (e.g., neural networks) to more efficiently (e.g., using less computing resources) and accurately identify objects.

According to certain aspects of the present disclosure, a machine learning system, such as a computer vision system, for identifying one or more objects may include a memory and a processor coupled therewith.

As part of a training phase, the processor and the memory may be configured to receive, for each of the one or more objects (e.g., a plurality of objects), a 3D digital representation of the object, the 3D digital representation of the object being associated with an identifier (e.g., label, name, etc.) of the object. The processor and the memory are further configured to generate, for each of the one or more objects, a number of 2D rendered images (e.g., one or more 2D rendered images, a plurality of 2D rendered images, etc.) based on the 3D digital representation of the object. Each of the number of 2D rendered images may be associated with an identifier of the object depicted in the 2D rendered image, based on the 3D digital representation being associated with the identifier. In some embodiments, a number of 2D representations (e.g., captured photos, reference images, renders, pictures, images, etc.) of the one or more objects is obtained in another suitable manner (e.g., through captured images of reference objects, etc.) and used in the manner described herein with respect to the number of 2D rendered images.

Continuing with the training phase, for each of the one or more objects, the processor and the memory are configured to generate a number of image codes. For example, the number of 2D rendered images of the object is input into a first machine-learning model, such as an artificial intelligence (AI) neural network. The first machine-learning model may be an image code generator and referred to as such. The first machine-learning model outputs a corresponding image code for each of the number of 2D rendered images. In particular, the first machine-learning model may not be specifically trained based on 2D representations of the one or more objects. The first machine-learning model may be a general model for classifying objects, and the image code may be an output of a layer of the first machine-learning model that is not the final output. Each of the number of image codes may be associated with the identifier of the object depicted in the 2D rendered image used to generate the image code, based on the 3D digital representation being associated with the identifier.

Further, during the training phase, the image codes and associated identifiers may then be used to train a second machine-learning model. In certain embodiments, the second machine-learning model is a part identification model, and may be referred to as such. In certain embodiments, the second machine-learning model outputs identifier information of an object (e.g., the actual identifier of the object, one or more probability values that the image code belongs to one or more (e.g., each) of the possible identifiers such as in a vector, etc.) based on an input of an image code. For example, the second machine-learning model may be trained by using supervised learning on a dataset that, for each of the image codes of each of the one or more objects, provides identifier information of the corresponding object and/or labels the image code with an identifier of the corresponding object. Where the identifier information includes probability values that the image code belongs to each of the possible identifiers, the identifier associated with the highest probability value may be determined to be the identifier of the object. In certain aspects, where multiple 2D rendered images of an object are used, the resultant multiple identifier information may be summed, averaged, or the like, and the identifier associated with the highest resultant probability value may be determined to be the identifier of the object.

After the training phase of the machine learning system, the trained system can be used to output an identifier of an object based on inputting an image of the object. For example, one or more captured images of a physical representation of a first object of the one or more objects may be provided as input to the first machine-learning model. The first machine learning model outputs a first image code in response to the input. The first image code is provided to the second machine-learning model as input. The second machine-learning model then outputs identifier information that is used to determine an identifier corresponding to the first object in response to the input of the first image code. Details of the object identification operations are described in the examples below.

### Example System for Object Identification

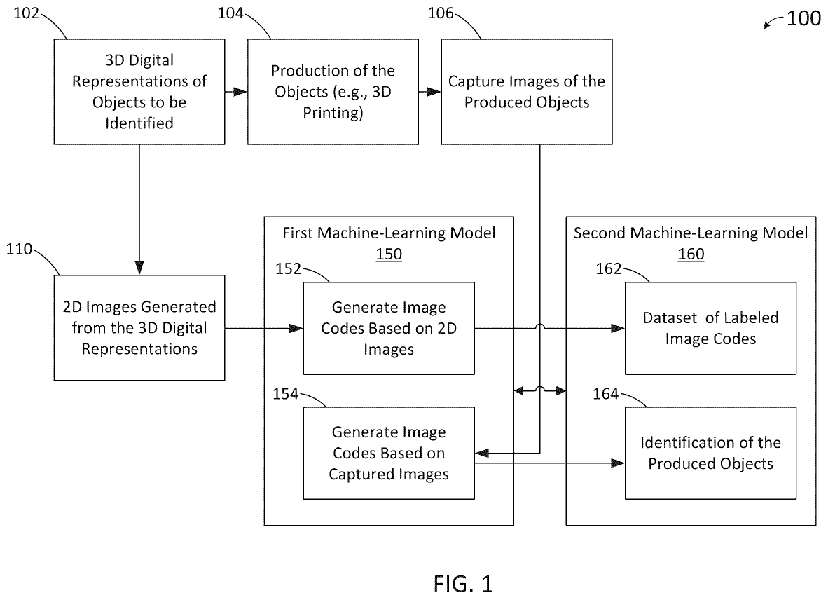

FIG. 1 depicts an example computer vision system 100 for identifying objects, according to aspects of the present disclosure. As shown, the computer vision system 100 is provided with a 3D digital representation 102 of each object to be identified. Each 3D digital representation may represent a shape, such as in terms of point coordinates, and may be in any suitable format, such as .stl, .obj, or the like (e.g., .x3d and others).

A 3D digital representation 102 may or may not be directly used for manufacture of the corresponding object. For example, the 3D digital representation 102 of an object may require further processing, such as slicing or conversion to instructions to be suitable for use for production of an object. In some cases, 3D digital representations of multiple objects are positioned (e.g., nested) with respect to one another in space (e.g., in a representation of a build area (also referred to as build volume)) such that the multiple objects are able to be manufactured together in a build cycle, such as using additive manufacturing.

As an example, the computer vision system 100 may include a processor, a memory, a work area, and one or more image acquisition components. The memory may store the 3D digital representations 102. The work area may produce (e.g., by 3D printing or CNC machining) or present (e.g., contain or receive) physical objects corresponding to one or more of the 3D digital representations 102. The one or more image acquisition components may include one or more cameras or camera components (e.g., separate lenses and sensors). In an implementation where one camera is used, the camera may move relative to the physical objects in the work area to capture images from different angles or orientations. In an implementation where two or more cameras are used, the multiple cameras (or separate components) may be placed at different orientations relative to the physical objects in the work area, for obtaining images of the physical objects at different viewpoints. In certain aspects, one or multiple captured images may be used out of the set of captured images (e.g., captured as a video stream) such as automatically by a computer program, or manually. The cameras may be inside or outside of the work area (e.g., when the work area is not fully enclosed or enclosed with transparent housing). The processor may perform computations based on the input from the cameras to perform object identification as described herein. In certain aspects, images of different objects are captured separately, meaning each image includes only one object. In certain aspects, images of multiple objects are captured, and the images are divided into separate images, such that each image includes one object. In certain aspects, an image includes multiple objects.

At 104, one or more objects corresponding to the 3D digital representations 102 are produced/manufactured. Although addictive manufacturing is referred to as an example production method for objects, the techniques of the present disclosure are equally applicable to traditional manufacturing techniques, such as CNC machining. In some cases, the objects may be transferred to the computer vision system 100 for identification or recognition. In some cases, the computer visions system 100 may be portable and transported to capture images of the produced objects. In some cases, the computer vision system 100 may be able to produce the objects.

At 106, the computer vision system 100 captures a number of images of the produced objects. For example, the computer vision system 100 may capture the number of images at different orientations relative to the produced objects to include features shown in different perspectives. The number of images may include one image per object, multiple images per object, one image of multiple objects, multiple images of multiple objects, or the like. In some cases, the computer vision system 100 moves the produced objects relative to a camera system thereof, such as on a movable bed or a conveyer belt. In some cases, the computer vision system 100 may employ multiple image sensors (e.g., an array of three or more cameras) arranged at different perspectives relative to the produced objects. The captured images may then be used for object identification.

At 110, the computer vision system 100 may generate or compute two-dimensional (2D) images from the 3D digital representations 102 of the objects. In certain aspects, each 3D digital representation 102 of an object is rendered from different viewpoints into multiple 2D images. The rendering may include applying texture, lighting, and shadows to create realistic virtual images of the 3D digital representations 102. A number of the 2D images at different viewpoints may be used to train the computer vision system 100 to recognize 3D objects based on 2D images input. In some cases, the rendering may be performed for multiple objects as arranged for production (e.g., as output from certain known build volume). In some cases, the rendering may be performed for each of objects corresponding to the 3D digital representations 102.

As shown, the computer vision system 100 may employ two machine-learning models. At 152 of the first machine-learning model 150 (e.g., the image code generator model), the 2D images generated at 110 from the 3D rendering may be used to generate image codes. That is, for each object having a 3D digital representation, a number of image codes are generated by the first machine-learning model 150. The first machine-learning model 150 may be an artificial intelligence (AI) neural network, such as a convolutional neural network with specific image categorization or classification network architecture, such as a ResNet50 architecture (e.g., which may be trained on an independent dataset such as the ImageNet dataset).

The first machine-learning model 150 may be designed to classify images into different categories based on visual features of the input images (2D rendered images here, which may be low resolution color images). The first machine-learning model 150 includes a layer (e.g., second to last layer, such as the last hidden layer) that outputs a corresponding image code for each of the number of 2D rendered images. In certain aspects, the image code summarizes the image information, such as in a vector of values referred to as a feature vector.

As shown at 152 and 162 of FIG. 1, the image codes are generated and extracted at the penultimate layer of the neural network (while the last layer outputs which category the 2D rendered image belongs to), and are then input to the second machine-learning model 160. At 162, the second machine-learning model 160 (e.g., the part identification model) may be trained by using supervised learning on a dataset that labels the image code with an identifier for each of the corresponding 3D digital representation of objects processed at 152.

At 154, the images of the produced objects captured at 106 are provided to the first machine-learning model 150 to generate image codes based on the captured images. For example, the captured images may depict physical features of a first object. Upon processing, the first machine learning model 150 outputs a first image code of the first object in response to the input.

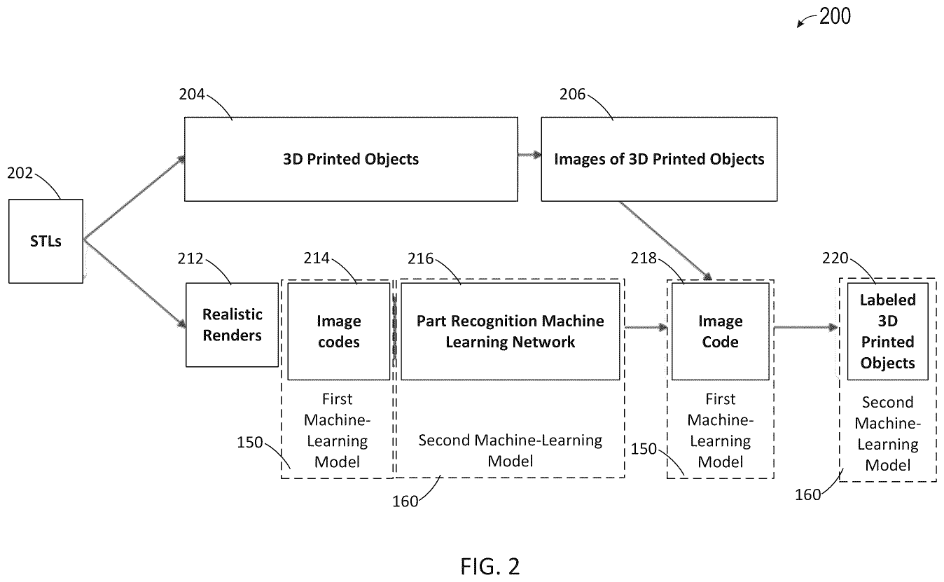

At 164, the first image code of the first object is provided to the second machine-learning model 160, and the second machine-learning model 160 outputs identifier information of the object, as discussed, such as the probability the object belongs to each of the possible labels. As discussed, the probability can be used to determine an identifier for the object. Based on the identifier, the computer vision system 100 identifies the first object. In some cases, the captured images may include multiple objects. The computer vision system 100 may identify each of the multiple objects. Furthermore, at 164, the computer vision system 100 may identify one or more objects of the 3D digital representations are missing, or if an object included in the captured images does not correspond to any of the objects of the 3D digital representations. An example of implementing the methods performed by the computer vision system 100 is provided in reference to FIG. 2 below. It should be noted that the steps of FIG. 1 need not be performed in the same order as described. For example, steps 104-106 may occur after or in parallel with one or more of steps 110, 152, and 162.

### Example Implementations of Object Identification

FIG. 2 depicts an example block diagram 200 of object identification, according to aspects of the present disclosure. At 202, a batch of standard triangle/tessellation language (STL or .stl) files are provided. The STL files represent digital shapes of objects to be identified. For example, the batch of STL files include a finite set of digital copies of objects to be physically manufactured. In certain implementations, the computer vision system 100 can recognize each manufactured object based on the STL files so that production quality monitoring of the manufacturing process can be automated.

At 204, the batch of STL files are processed (e.g., sliced and loaded) in one or more 3D printers and become 3D printed objects. In some cases, the printed objects may be post processed (e.g., support removal, cleaning, etc.). At 206, images of the 3D printed objects are captured (e.g., at various viewpoints). In some cases, the images may be taken for each of the 3D printed objects in turn. In certain aspects, the images may be of low resolution (e.g., less than 300 pixels by 300 pixels) In some cases, the images may be taken for the batch of 3D printed objects together. In certain aspects, the images may be of a higher native resolution (e.g., 1000 pixels by 1000 pixels or higher) and post processed to isolate each object at a lower resolution (e.g., 300 pixels by 300 pixels or lower).

At 212, each of the batch of STL files may be realistically rendered (e.g., adding lighting, shadows, texture, and/or background, etc.) and a number of 2D images may be generated at various viewpoints (e.g., random viewpoints). In certain aspects, the realistic renders (or virtual images) are computed for all STL files in the batch. For example, for each STL file, several tens of renders may be made from random viewpoints to fully capture what an object may look like from different perspectives.

At 214, these generated 2D images are input in the first machine-learning model 150, which outputs image codes. The first machine-learning model 150 may be a classifier network. In certain aspects, one or more image codes are output for an input 2D image. In certain aspects, the one or more image codes summarize features of the object corresponding to the input 2D image.

In one example, the first machine-learning model 150 may be a convolutional neural network with a specific network architecture, such as ResNet50, trained to classify a large dataset of images such as ImageNet. The output used may not be the last layer of this classifier, but for example the last hidden network layer, that summarizes the information visible on the input image in an image code that is a vector.

For example, the image code may include 2048 floats. According to aspects of the present disclosure, the image code is used as a compact description of the input image and the subsequent categorization may be ignored. It is important to note that it does not matter what exactly is visible on the image: even if the image does not show any of the categories. The image codes will still contain values that somehow summarize the image information. An image code may be computed for each of the 2D rendered images.

At 216, the second machine-learning model 160 is trained with the image codes, such as using supervised learning as discussed. The second machine-learning model 160 may include another neural network that takes an image code as input and returns a vector of floats. In certain aspects, this neural network is specifically designed and trained to identify the current objects. The length of the output vector may be equal to the number of objects in the set of STL files. The values of the vector of floats may indicate the probability for an input image code (which represents an image) to correspond to each of the objects represented by the STL files. During training of the second neural network, the second machine-learning model 160 learns to understand which image codes belong to which object of the STL files. According to aspects of the present disclosure, the second machine-learning model 160 is specifically trained for the objects represented in the batch of STL files.

At 218, the images of the actual 3D printed objects from 206 are input to the first machine-learning model 150, which outputs image codes corresponding to the input images.

At 220, the second machine-learning model 160 identifies/labels the 3D printed objects captured in the images based on the image codes obtained at 218. For example, the image codes corresponding to the images are input to the second machine-learning model 160. For each image, a probability vector is returned by the second machine-learning model 160. Often, identifying an object based on a single image or perspective would be difficult. In certain aspects, the probability vectors computed from multiple images corresponding to the same object at different viewpoints are used and averaged.

Amongst the values of the probability vector for an image of an object, the highest probability is used to determine the identifier/label to assign to the image, and accordingly the object, thereby identifying the object. Each object may then be assigned a label based on the images taken at 206 for that object. In some cases, a consistency test may be performed: for each label, there should be one and only one corresponding pictures set and vice versa. This consistency check may be used to identify wrongly classified parts.

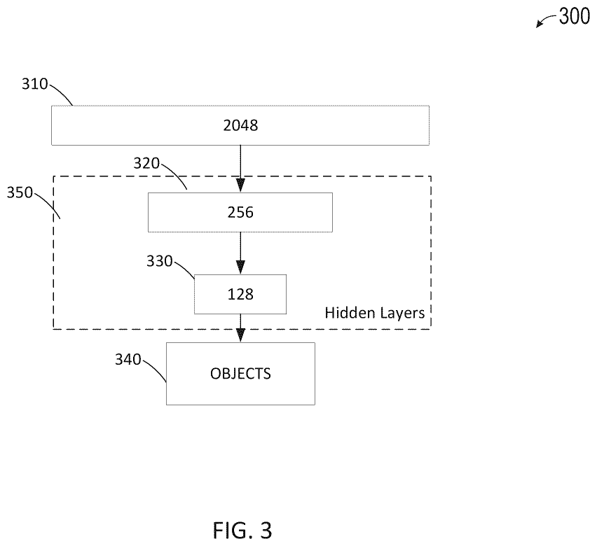

FIG. 3 depicts an example machine-learning model 300, according to aspects of the present disclosure. The machine-learning model 300 may be the second machine-learning model 160 as mentioned above in reference to FIGS. 1 and 2. According to aspects of the present disclosure, the machine-learning model 300 is a dense network. As shown, the machine-learning model 300 includes hidden layers 350 that are densely connected. The machine-learning network 300 may be a small network with two hidden layers (e.g., 320 and 330) and a relatively small number of network weights.

As an example, the machine-learning model 300 receives an input 310 of a feature vector of 2048 values (e.g., the first layer). The dense layers 320 and 330 respectively include 256 nodes (or neurons) and 128 nodes, which are for illustrative purposes only. The actual dimensions of the dense layers 320 and 330 may be scaled depending on the number of objects in the dataset.

The arrows as shown in FIG. 3 represent simplified connections between the layers of the dense network. Each node or neuron in each layer is connected to every other node in the next layer. Each node to node connection may be weighted. The weight parameter may be trained in the training phase.

Upon training completion, the weight parameters are fixed to the learned values. The machine-learning model 300 is then ready to be used for object identification based on images of the physical objects. For example, the output 340 of the machine-learning model 300 may be a vector of values that each indicate the probability that the image corresponds to one of the objects in the 3D digital representations.

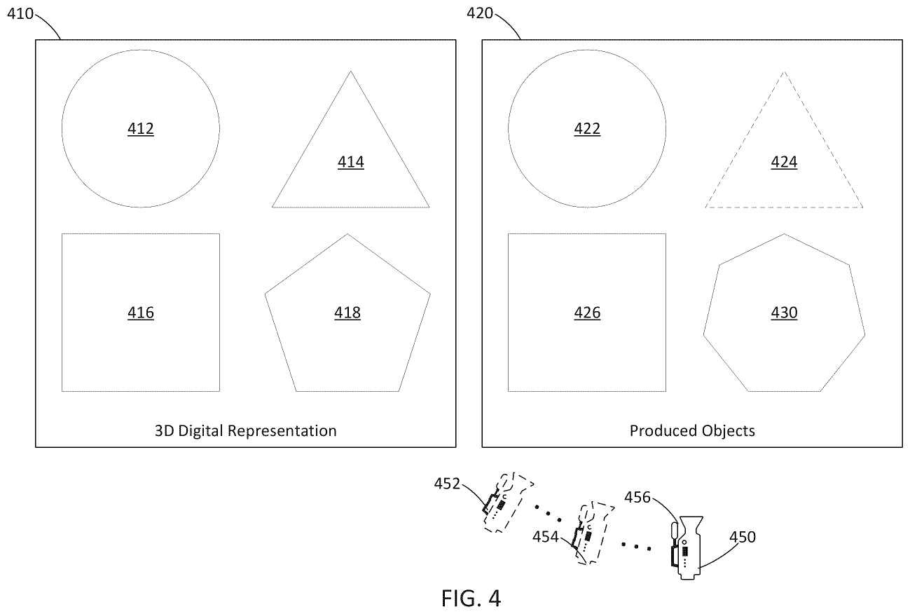

FIG. 4 depicts an example object identification process and output, according to aspects of the present disclosure. As shown, a batch of objects (412, 414, 416, and 418) are provided in 3D digital representations 410, such as in various 3D mesh formats. The batch of objects 412, 414, 416, and 418 may be of different categories or belong to different classifications (e.g., separate and irrelevant). As described in reference to FIGS. 1-3, the 3D digital representations 410 may be sent for production. A collection of produced objects 420 may be placed within a work area, which may be a build volume of 3D printing, or a stage area for images to be taken. One objective according to aspects of the present disclosure is to automatically identify and match each object in the produced objects 420 to a corresponding shape or model in the 3D digital representation 410 using machine-learning models.

A camera 450 may be positioned at different viewpoints 452, 454, or 456 relative to the produced objects 420 for taking multiple images thereof. In some cases, multiple cameras may be positioned at different viewpoints to obtain the multiple images with reduced relative movement between the cameras and the produced objects 420.

Upon processing the images taken at various viewpoints using the techniques discussed above, each of the produced objects may be identified (e.g., at 164). As shown, the object 422 may be identified and labeled as the object 412 of the 3D digital representation Similarly, the object 426 may be identified and labeled as the object 416 of the 3D digital representation. In some cases, parts may go missing in production. In some cases, parts may fail to be correctly made in production.

As shown, it is possible to identify a missing object 424 that corresponds to the object 414 of the 3D digital representation. Similarly, a wrong or failed object 430 may also be identified, such as by identifying a corresponding object 418 missing in the produced objects 420 or by identifying a low matching probability (e.g., below certain confidence threshold). As such, missing or unknown objects in the produced objects 420 may be identified and labeled.

### Example Methods for Object Recognition

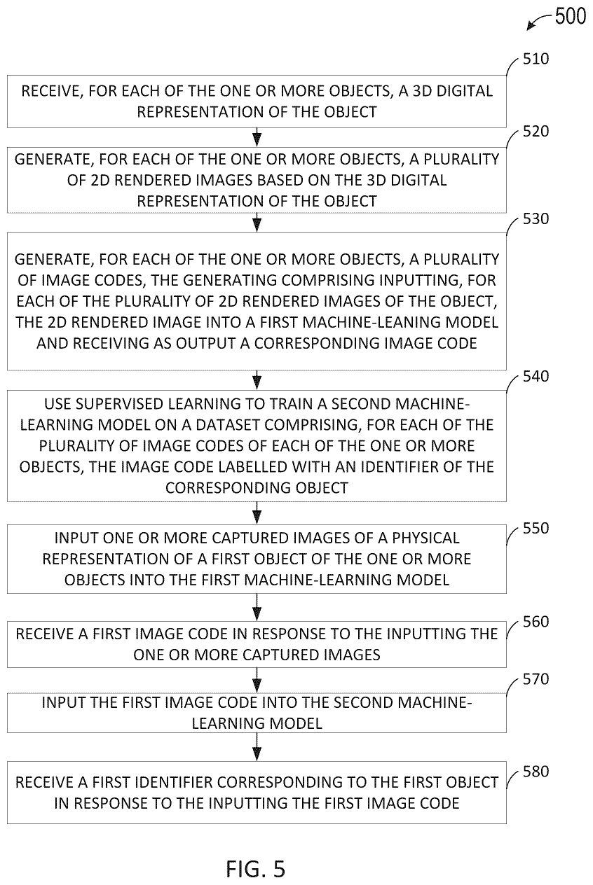

FIG. 5 depicts an example method 500 for identifying one or more objects using machine-learning models, according to some embodiments. The example method 500 may be performed by a computer vision system, such as the computer vision system 100 discussed in relation to FIGS. 1 and 2.

The method 500 begins at operation 510 by receiving, for each of the one or more objects, a 3D digital representation of the object.

The method 500 then proceeds to operation 520 with generating, for each of the one or more objects, a number of 2D rendered images based on the 3D digital representation of the object, such as described above with respect to FIGS. 1 and 2.

In certain aspects, instead of operations 510 and 520, the method 500 includes obtaining, for each of the one or more objects, a plurality of 2D representations of the object. Further, in certain aspects, instead of using 2D rendered images, method 500 uses 2D representations.

The method 500 then proceeds to operation 530 with generating, for each of the one or more objects, a plurality of image codes. For example, the generating includes inputting, for each of the plurality of 2D rendered images of the object, the 2D rendered image into a first machine-leaning model and receiving as output a corresponding image code.

In some cases, for each of the one or more objects, each of the plurality of image codes includes a corresponding feature vector indicating a probability of the corresponding 2D rendered image matching a category for each of a plurality of categories. In some cases, the first machine-learning model includes a convolutional neural network having a number of computation layers. The feature vector may be an output of a hidden layer of the number of computation layers of the first machine-learning model.

The method 500 then proceeds to operation 540 with using supervised learning to train a second machine-learning model on a dataset comprising, for each of the plurality of image codes of each of the one or more objects, the image code labelled with an identifier of the corresponding object.

In some cases, the second machine-learning model includes a network having hidden layers densely connected. The second machine-learning model may be trained only on the dataset specific to the one or more objects and the corresponding 3D digital representations.

The method 500 then proceeds to operation 550 with inputting one or more captured images of a physical representation of a first object of the one or more objects into the first machine-learning model.

The method 500 then proceeds to operation 560 with receiving a first image code in response to the inputting the one or more captured images. For example, the one or more captured images include a plurality of captured images that are captured from at least two different viewpoints or orientations.

The method 500 then proceeds to operation 570 with inputting the first image code into the second machine-learning model.

The method 500 then proceeds to operations 580 with receiving or determining a first identifier corresponding to the first object in response to the inputting the first image code.

In some cases, the captured images of physical representations of multiple objects may be input to the first machine-learning model, which outputs multiple image codes. The multiple image codes output by the first machine-learning model are input to the second machine-learning model, which outputs multiple identifiers corresponding to the multiple objects.

The method 500 may further include outputting an identification report, which includes a corresponding identifier of each of the multiple objects identified in the captured images. The identification report may further include an indication of at least one object of the one or more objects not identified in the captured images.

Note that FIG. 5 is just one example of a method, and other methods including fewer, additional, or alternative steps, or steps in a revised order, are possible consistent with this disclosure.

### Example Controller for Computer Vision System for Object Identification

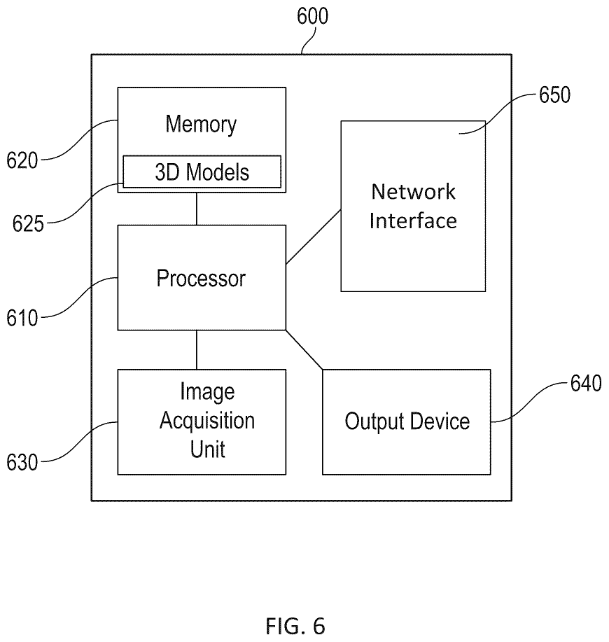

FIG. 6 depicts a functional block diagram of one example of a computer vision system 600, which may be implemented as the computer vision system 100 of FIG. 1. The computer vision system 600 includes a processor 610 in data communication with a memory 620, an input device 630, and an output device 640. The processor 610 may be configured to perform various computation tasks, including executing one of the first machine-learning model 150, the second machine-learning model 160, or both. In some cases, the processor 610 may access cloud computing functionalities via the network interface 650.

Though not shown, other computers may have similar components as shown for computer vision system 600. Although described separately, it is to be appreciated that functional blocks described with respect to the computer vision system 600 need not be separate structural elements. For example, the processor 610 and memory 620 may be embodied in a single chip.

The processor 610 can be a general purpose processor, a digital signal processor (“DSP”), an application specific integrated circuit (“ASIC”), a field programmable gate array (“FPGA”) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 610 can be coupled, via one or more buses, to read information from or write information to memory 620. The processor may additionally, or in the alternative, contain memory, such as processor registers. The memory 620 can include processor cache, including a multi-level hierarchical cache in which different levels have different capacities and access speeds. The memory 620 can also include random access memory (RAM), other volatile storage devices, or non-volatile storage devices. The storage can include hard drives, flash memory, etc.

The memory 620 may store a batch of 3D models 625. The batch of 3D models 625 may be rendered and converted to multiple 2D rendered images of random viewpoints, and may be processed for production, such as sliced for 3D printing or converted to computer numerical control (CNC) codes for machining. In various instances, the memory 620 may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

The processor 610 also may be coupled to an input device 630 and an output device 640 for, respectively, receiving input from and providing output to a user of the computer vision system 600. The input device 630 may include one or more cameras, such as the camera 450 of FIG. 4. Other suitable input devices 630 include, but are not limited to, a keyboard, buttons, keys, switches, a pointing device, a mouse, a joystick, a remote control, an infrared detector, a bar code reader, a scanner, a motion detector, or a microphone (possibly coupled to audio processing software to, e.g., detect voice commands). The output device 640 may include one or more visual output devices, such as displays for indicating the object identification results. Other suitable output devices 640 include, but are not limited to, printers, audio output devices, including speakers, headphones, earphones, and alarms, additive manufacturing machines, and haptic output devices.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps, operations, or actions for achieving the methods. The method steps, operations, and/or actions may be interchanged with one another without departing from the scope of the claims. In other words, unless a specific order of steps, operations, or actions is specified, the order and/or use of specific steps, operations, and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Various embodiments disclosed herein provide for the use of a computer control system. A skilled artisan will readily appreciate that these embodiments may be implemented using numerous different types of computing devices, including both general purpose and/or special purpose computing system environments or configurations. Examples of well-known computing systems, environments, and/or configurations that may be suitable for use in connection with the embodiments set forth above may include, but are not limited to, personal computers, server computers, hand-held or laptop devices, multiprocessor systems, microprocessor-based systems, programmable consumer electronics, network PCs, minicomputers, mainframe computers, distributed computing environments (e.g., networks, cloud computing systems, etc.) that include any of the above systems or devices, and the like. These devices may include stored instructions, which, when executed by a microprocessor in the computing device, cause the computer device to perform specified actions to carry out the instructions. As used herein, instructions refer to computer-implemented steps for processing information in the system. Instructions can be implemented in software, firmware or hardware and include any type of programmed step undertaken by components of the system.

A microprocessor may be any conventional general purpose single-or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

Aspects and embodiments of the disclosure herein may be implemented as a method, apparatus or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

As used herein, the term “about” may refer to a +/−10% variation from the nominal value. It is to be understood that such a variation can be included in any value provided herein.

As used herein, the term “couple” and “coupled” may be coupled as indirectly or directly.

The following claims are not intended to be limited to the embodiments shown herein, but are to be accorded the full scope consistent with the language of the claims Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for identifying one or more objects by a computer vision system, comprising:
obtaining, for each of the one or more objects, a plurality of 2D representations of the object;
generating, for each of the one or more objects, a plurality of image codes, the generating comprising inputting, for each of the plurality of 2D representations of the object, the 2D representation into a first machine-leaning model and receiving as output a corresponding image code;
using supervised learning to train a second machine-learning model on a dataset comprising, for each of the plurality of image codes of each of the one or more objects, the image code labelled with an identifier of a corresponding object;
inputting one or more captured images of a physical representation of a first object of the one or more objects into the first machine-learning model;
receiving a first image code in response to the inputting the one or more captured images;
inputting the first image code into the second machine-learning model; and
determining a first identifier corresponding to the first object in response to the inputting the first image code.

2. The method of claim 1, wherein, for each of the one or more objects, each of the plurality of image codes comprises a corresponding feature vector indicating a probability of the corresponding 2D representation matching a category for each of a plurality of categories.

3. The method of claim 2, wherein the first machine-learning model comprises a convolutional neural network having a plurality of computation layers, an output of a hidden layer of the plurality of computation layers of the first machine-learning model being the feature vector.

4. The method of claim 1, wherein the second machine-learning model comprises a network having hidden layers densely connected.

5. The method of claim 1, wherein the second machine-learning model is trained only on the dataset specific to the one or more objects and the corresponding 2D digital representations.

6. The method of claim 1, wherein the one or more captured images comprise a plurality of captured images that are captured from at least two different viewpoints or orientations.

7. The method of claim 1, wherein the one or more objects comprise a plurality of objects, and further comprising:
inputting captured images of physical representations of the plurality of objects into the first machine-learning model;
receiving a plurality of image codes in response to inputting the captured images;
inputting the plurality of image codes into the second machine-learning model;
receiving a plurality of identifiers corresponding to the plurality of objects in response to the inputting the plurality of image codes; and
outputting an identification report comprising:
a corresponding identifier of each of the plurality of objects identified in the captured images, and
an indication of at least one object of the one or more objects not identified in the captured images.

8. The method of claim 1, wherein the plurality of 2D representations of the object comprise a plurality of 2D rendered images, and wherein obtaining, for each of the one or more objects, the plurality of 2D representations of the object comprises:
receiving, for each of the one or more objects, a 3D digital representation of the object; and
generating, for each of the one or more objects, the plurality of 2D rendered images based on the 3D digital representation of the object.

9. The method of claim 1, further comprising selecting the one or more captured images from a plurality of captured images corresponding to a video stream.

10. A computer vision system, comprising: a memory comprising computer-executable instructions; and one or more processors configured to execute the computer-executable instructions and cause the computer vision system to perform operations for identifying one or more objects comprising:
obtaining, for each of the one or more objects, a plurality of 2D representations of the object;
generating, for each of the one or more objects, a plurality of image codes, the generating comprising inputting, for each of the plurality of 2D representations of the object, the 2D representation into a first machine-leaning model and receiving as output a corresponding image code;
using supervised learning to train a second machine-learning model on a dataset comprising, for each of the plurality of image codes of each of the one or more objects, the image code labelled with an identifier of a corresponding object;
inputting one or more captured images of a physical representation of a first object of the one or more objects into the first machine-learning model;
receiving a first image code in response to the inputting the one or more captured images;
inputting the first image code into the second machine-learning model; and
determining a first identifier corresponding to the first object in response to the inputting the first image code.

11. The computer vision system of claim 10, wherein, for each of the one or more objects, each of the plurality of image codes comprises a corresponding feature vector indicating a probability of the corresponding 2D representation matching a category for each of a plurality of categories.

12. The computer vision system of claim 11, wherein the first machine-learning model comprises a convolutional neural network having a plurality of computation layers, an output of a hidden layer of the plurality of computation layers of the first machine-learning model being the feature vector.

13. The computer vision system of claim 10, wherein the second machine-learning model comprises a network having hidden layers densely connected.

14. The computer vision system of claim 10, wherein the second machine-learning model is trained only on the dataset specific to the one or more objects and the corresponding 3D digital representations.

15. The computer vision system of claim 10, wherein the one or more captured images comprise a plurality of captured images that are captured from at least two different viewpoints or orientations.

16. The computer vision system of claim 10, wherein the one or more objects comprise a plurality of objects, and wherein the operations further comprise:
inputting captured images of physical representations of the plurality of objects into the first machine-learning model;
receiving a plurality of image codes in response to inputting the captured images;
inputting the plurality of image codes into the second machine-learning model;
receiving a plurality of identifiers corresponding to the plurality of objects in response to the inputting the plurality of image codes; and
outputting an identification report comprising:
a corresponding identifier of each of the plurality of objects identified in the captured images, and
an indication of at least one object of the one or more objects not identified in the captured images.

17. The computer vision system of claim 10, wherein the plurality of 2D representations of the object comprise a plurality of 2D rendered images, and wherein obtaining, for each of the one or more objects, the plurality of 2D representations of the object comprises:
receiving, for each of the one or more objects, a 3D digital representation of the object; and
generating, for each of the one or more objects, the plurality of 2D rendered images based on the 3D digital representation of the object.

18. The computer vision system of claim 10, wherein the operations further comprise selecting the one or more captured images from a plurality of captured images corresponding to a video stream.

19. A non-transitory computer-readable medium comprising computer-executable instructions that, when executed by one or more processors of a processing system, cause the processing system to perform a method for identifying one or more objects by a computer vision system, comprising:
obtaining, for each of the one or more objects, a plurality of 2D representations of the object;
generating, for each of the one or more objects, a plurality of image codes, the generating comprising inputting, for each of the plurality of 2D representations of the object, the 2D representation into a first machine-leaning model and receiving as output a corresponding image code;
using supervised learning to train a second machine-learning model on a dataset comprising, for each of the plurality of image codes of each of the one or more objects, the image code labelled with an identifier of a corresponding object;
inputting one or more captured images of a physical representation of a first object of the one or more objects into the first machine-learning model;
receiving a first image code in response to the inputting the one or more captured images;
inputting the first image code into the second machine-learning model; and
determining a first identifier corresponding to the first object in response to the inputting the first image code.

20. The non-transitory computer-readable medium of claim 19, wherein, for each of the one or more objects, each of the plurality of image codes comprises a corresponding feature vector indicating a probability of the corresponding 2D representation matching a category for each of a plurality of categories.
